(19) United States
(12) Patent Application Publication
(10) Pub. No.: US 2010/0109471 A1
(43) Pub. Date: May 6, 2010

(54) STATOR FOR A MULTIPLE PHASE ROTARY ELECTRIC MACHINE, MULTIPLE PHASE ROTARY ELECTRIC MACHINE INCLUDING SUCH ROTOR, AND METHOD FOR MAKING SUCH ROTOR

(76) Inventor: Richard Tellier, Saint-Maur (FR)

Correspondence Address: BERENATO & WHITE, LLC, 6550 ROCK SPRING DRIVE, SUITE 240, BETHESDA, MD, 20817, US

(21) Appl. No.: 12/515,696

(22) PCT Filed: Dec. 20, 2007
(86) PCT No.: PCT/FR07/52596

§ 371 Date: Dec. 8, 2009

(30) Foreign Application Priority Data
Dec. 22, 2006 (FR) 0655842

(51) Int. Cl. H02K 1/16; H02K 15/085

(52) U.S. Cl. 310/216.074; 29/596

(57) ABSTRACT

A stator for a multiple-phase rotary electrical machine, in which each phase includes at least one winding, each winding including coils (70) with several turns (73), the stator (5) comprising a body (50) having an axial length (L) and having on the inside a plurality of notches (60) defined by teeth (61), each tooth (61) being surrounded by a coil (70), wherein the body (50) of the stator (5) includes two complementary annular parts (501, 502) each part having a partial axial length (L1, L2), the teeth (61) of the body (50) being alternately connected to one or the other of said parts (501, 502) of the stator (5) body (50). A multiple-phase rotary electric machine is also discloses that comprises a stator as described above. The method of producing the stator comprises the following steps: surrounding the teeth (61) of the first part (501) and the teeth (61) of the second part (502) of the stator's (5) body (50) with a coil (70) and assembling the two parts (501, 502) of the stator (5) body (50).

### FIELD OF THE INVENTION

The invention concerns a stator for a multiple-phase rotary electrical machine, a multiple-phase rotary electrical machine including such a rotor and a method of making such a rotor.

The invention finds applications in the automotive industry and in particular in the field of alternators and alternator-starters for automotive vehicles.

### STATE OF THE ART

Depending on their design, rotary electrical machines are used as electric current generators, electric motors or reversible machines that can operate as a generator and as a motor.

An electric current generator, for example a multiple-phase alternator, transforms a rotation movement of the excitation rotor, driven for example by an internal combustion engine, into an induced electric current in the coil of the stator. Conversely, an electric current applied to the coil of the stator of the electrical machine drives in rotation, via the rotor shaft, a member constrained to rotate with the rotor shaft. Thus in this operating mode the electrical machine transforms electrical energy into mechanical energy. A typical example of a rotary electrical machine transforming a rotation movement into an electric current is the alternator used in automotive vehicles to supply the electricity necessary for the operation of different units installed onboard the automotive vehicle. For this same application field, a typical example of a rotary electrical machine transforming electrical energy into mechanical energy is a starter motor.

Alternatively, the rotary electrical machine can be a reversible machine designed for use in the automotive field as an alternator-starter, i.e. a machine which when operating in current generator mode executes the alternator function and when operating in electric motor mode executes the starter motor function.

In an alternator or in an alternator-starter operating in current generator mode the stator is the armature element and the rotor is the field element. Conversely, in an alternator-starter operating in electrical motor mode the stator is the field element and the rotor is the armature element.

Rotary electrical machines such as alternators and alternator-starters include a casing in at least two parts, called the front bearing and the rear bearing, supporting a stator surrounding a rotor fastened to a rotor shaft which carries at one of its axial ends a movement transmission member, such as a pulley or a gear, that is part of a device for transmission of motion between the internal combustion engine and the alternator or the alternator-starter.

The rotor includes as least one field coil connected to a voltage regulator. The stator includes a body carrying a coil consisting of a number of phases, each including at least one winding, the outputs of which are electrically connected to a rectifier device for rectifying the alternating current produced in the phases of the stator, when the stator is the armature, and a direct current for charging the battery and/or supplying power to power consuming units of the onboard network of the automotive vehicle. The rectifier device includes a diode bridge for example.

The field coil of the rotor can be fixed and connected to the voltage regulator or installed in the rotor. In this case, the rotor shaft carries at its other axial end collector rings connected by wires to the ends of the field coil. Brushes that are part of a brush-holder connected to the voltage regulator rub on the collector rings.

The body of the stator is usually laminated to reduce Eddy currents. The laminations include a plurality of notches which are aligned to form axial grooves.

The notches are of the closed or semi-closed type and, in this case, each notch opens onto the internal periphery of the body of the stator. Alternate notches are delimited by teeth, two consecutive notches being separated by a tooth.

The windings of the stator coils are mounted in the notches, the number of which varies according to the application and the number of phases. Accordingly, for a three-phase rotary electrical machine having a claw-pole type rotor including two pole wheels each having six teeth, for example, the stator has 36 notches.

In one embodiment, the windings are continuous wire windings produced in an undulating or interleaved manner in the notches around a number of teeth, for example. With continuous wire windings, the ratio of filling of the notches by the windings is not as high as might be wished.

Alternatively, to increase the power of the machine and to increase the notch filling ratio, the windings are bar windings comprising bars connected by welding them to each other.

In a further variant, each of the teeth is surrounded by only one coil.

The advantage of multiple-phase rotary electrical machines over single-phase rotary electrical machines is that the ripple of the armature current can be reduced by increasing the number of phases and a more stable voltage obtained. At the same time, to increase the power of the machine, it is necessary to increase the number of windings. Whereas increasing the number of phases increases the number of teeth and therefore reduces the width of the notches for a given rotor circumference, increasing the number of windings or the notch filling ratio means that the windings must be disposed more and more tightly with respect to each other. This results in the practical problem of producing windings in a small space.

A solution proposed in the document US2005/0269895A1 winds the coils on teeth separate from the stator and then inserts the “equipped” teeth back into the stator. In the example of a stator with 28 teeth described later, this solution would impose managing and handling a large number of parts, namely 28 teeth, the corresponding 28 coils and possibly 28 notch insulators. Moreover, such a solution would, at least a priori, make it impossible to produce continuous wire windings.

This results in the problem of having to facilitate the production of windings of a stator of an electrical machine if the number of teeth is high and the space between the teeth cannot be increased without increasing the size of the body of the stator and therefore of the electrical machine.

### STATEMENT OF INVENTION

Thus the object of the invention is to remedy the above drawbacks.

The object of the invention is achieved by a stator of a multiple-phase rotary electrical machine, each phase including at least one winding, each winding including coils with a plurality of turns, the stator having a body having an axial length and having internally a plurality of notches delimited by teeth each of which is surrounded by a coil.

According to the invention, the body of the stator comprises two complementary annular parts each having a partial axial length, the teeth of the body being alternately fastened to one or the other of the two parts of the stator body.

Thanks to the invention, the notch filling ratio can be increased whilst retaining some of the ease of producing the windings.

By producing two half-stators, each of them includes only half the teeth and therefore has notches or spaces twice as large. These larger spaces between two consecutive teeth can be provided with coils wound in situ by standard winding machines. Instead of having to load and unload the winding station a number of times equal to the number of teeth, for example 28 times, it is loaded and unloaded only twice.

Even when the final turns of a coil are being produced, there remains sufficient room for the wire and the guides. Finally, if the electrical circuit diagram lends itself to this, the coils of the same electrical circuit situated on the same half-stator can be produced continuously, which eliminates having to connect these coils subsequently.

Moreover, the distribution or division of the body of the stator into two complementary concentric annular parts does not impose the formation of two body parts of exactly the same axial length, but encompasses the possibility of forming two body parts with different axial lengths, for example if design aspects of the rotary electrical machine make that advantageous. The teeth of the body of the rotor being distributed over two body parts in such a manner that they are alternately fastened to one or the other of the two parts of the body, each of the two parts of the body has whole teeth. Consequently, the fixing of the windings to the teeth is independent of the axial length of the two parts of the rotor body.

It is advantageous if the axial lengths of the two parts of the rotor body are the same, but this is not essential.

To the extent that multiple-phase rotary electrical machines can also be used to generate current in the coils of an electromagnetic retarder, it is advantageous for the stator to be conformed so that it is in thermal contact with a surrounding water jacket.

More particularly, the stator of the invention can be conformed to be surrounded by at least one turn of a pipe forming a water jacket for water-cooling the stator.

In an alternative embodiment, each of the two parts of the rotor's body is conformed to constitute a corresponding half of a water jacket for water-cooling the stator.

The object of the invention is also achieved by a method of producing a stator for a multiple-phase rotary electrical machine in which each phase includes at least one winding and each winding includes coils with multiple turns, the stator then being provided with a body having an axial length and featuring internally a plurality of notches delimited by teeth each of which is intended to be surrounded by a coil, the body having two complementary annular parts each having a partial axial length and being alternatively fastened to one and the other of the teeth.

A multiple-phase rotary electrical machine is characterised in that it includes a stator of the invention.

According to the invention, the method comprises the following steps:

surrounding the teeth of the first part of the stator body and then the teeth of the second part of the stator body with a coil, and

assembling the two parts of the body of the stator.

As the method also demonstrates, the invention produces a rotary electrical machine stator with its windings in two parts and then assembles them, which more particularly, for the production of the windings, provides sufficient room around each of the teeth intended to carry a winding, at the same time as producing a very high ratio of filling of the notches of the stator.

Moreover, the invention provides great flexibility in the placement of notch insulators, should they be necessary.

Thanks to the invention, it is possible to place notch insulators in the notches before fitting the coils, whereas, as an alternative to this, if the notches are of the open type, it is possible first to fit each coil around an insulator and then to fit the assembly to the corresponding tooth.

### BRIEF DESCRIPTION OF THE DRAWINGS

FIG. 1 represents an internally ventilated alternator including a stator of the invention;

FIG. 2 is a perspective view of a stator of the invention;

FIG. 3 is a perspective view of one of two parts of a stator of the invention;

FIG. 4 is a perspective view of two parts of the body of a stator of the invention, the parts being axially aligned ready for assembly; and

FIG. 5 is a perspective view of a coil mounted on its associated tooth, the notches being of the open type.

### DETAILED DESCRIPTION OF ONE EMBODIMENT OF THE INVENTION

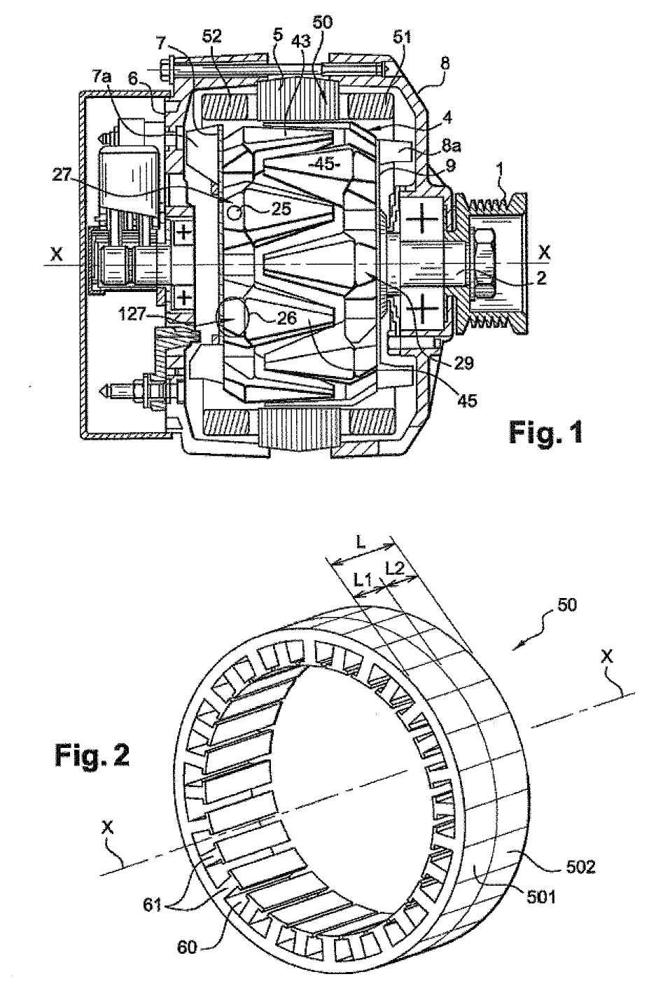

FIG. 1 represents an internally ventilated automotive vehicle alternator equipped with two fans.

This alternator includes (see above) a movement transmission member 1 in the form of a pulley that is part of a device, not shown in FIG. 1, for transmission of motion between the internal combustion engine of the vehicle and the alternator. There passes partly through this member 1 a rotation shaft 2 with which it is constrained to rotate and the axis X-X of axial symmetry of which constitutes the rotation axis of the machine.

This rotation shaft 2 carries a rotor 4, for example a claw-pole rotor, provided with at least one field coil also known as an excitation coil. The rotor 4 is surrounded by a wound stator 5 which includes one or more windings per phase to constitute the armature coil. The rotor 4 is carried by a front bearing 8 and a rear bearing 6 both including at their axial ends a ball bearing supporting the rotation shaft 2.

The axis X-X also constitutes the axis of the rotor 4 and the stator 5.

The bearings 6, 8 are hollow and are connected together by tie-rods (no reference numbers) to form a casing carrying internally the stator 5 of the invention.

The rear bearing 6 carries a brush-holder (no reference number) the brushes of which are adapted to rub on collector rings (no reference numbers) connected by wire connections to the field or excitation coil (not visible) that the claw-pole rotor 4 includes between its two pole wheels 27, 29 each having axially-oriented teeth 45 that are interleaved. Magnetic poles are formed, at the rate of one pole per tooth 45 of the pole wheel, when the excitation coil of the rotor is supplied with electrical power.

Drilling areas 26 are provided in the base 127 of at least one tooth 45 of the rotor for dynamically balancing the rotor. This balancing is effected by removing material, which produces a blind hole 25.

In the FIG. 1 example, the alternator includes two fans, one fan 9 at the front of the rotor and a fan 7 at the rear, both fastened to the rotor. A different embodiment of the alternator could include a single fan, generally the rear fan 7, more powerful than the front fan 9 located at the same end as the drive pulley 1.

It is seen in this FIG. 1 that the stator includes a body 50 fastened to the bearings 6, 8 and perforated for internal circulation of air by the fans 7, 9. This body 50 carries a coil, described hereinafter, whose ends 51, 52, referred to herein as bun-shaped assemblies, extend the full length of the body 50 of the stator 5.

These bun-shaped assemblies 51, 52 must be cooled by the fans. It is therefore desirable for the coil of the stator to be of an appropriate configuration allowing good passage of air in the region of the bun-shaped assemblies.

Alternatively, the alternator is cooled by circulation of a cooling liquid, such as the cooling water of the internal combustion engine of the vehicle. In this case the casing includes a chamber for circulation of the cooling water. For example, this chamber is part of the hollow rear bearing closed at the front by a cap constituting the front bearing. Alternatively, the chamber can be part of both the bearings. A solution with seals of the type described in the document FR 2 793 083 can instead be adopted. Thus the body of the stator can define a cylindrical face of the chamber.

Alternatively a solution of the type described in the document WO 2005/062444 can be adopted, the alternator then constituting the current generator of the electromagnetic retarder. The body of the stator is [sic]

Alternatively, the alternator is cooled both by circulation of the cooling water of the internal combustion engine and by circulation of air.

For example, the casing can be in three parts, the body 50 of the stator being carried by an intermediate casing part between the front and rear bearings. This intermediate part is then provided with the water circulation chamber which can in one embodiment also be part of one of the bearings.

In all cases, it is desirable to increase the power and the performance of the alternator, which alternatively is reversible and consists of an alternator-starter as described for example in the document WO 01/69762 or in the document FR A 2 745 444, which may be referred to.

Here the body 50 of the stator is laminated to reduce Eddy currents. This body 50 and the stator 5 have an annular shape.

The laminations include notches 60 (FIGS. 2, 5). These notches 60 are aligned to form axial grooves.

The notches 60 in FIG. 2 are of the semi-closed type but can equally be of the type open toward the internal periphery of the body 50, as can be seen in FIG. 5. This internal periphery delimits a cylindrical bore with a small airgap between the internal periphery of the body 50 of the stator 5 and the external periphery of the annular ferromagnetic material rotor 4.

The notches 60 have in both cases an opening at the internal periphery of the body 50, this opening being wider in FIG. 5 than in FIG. 2.

The notches 60 therefore open toward the interior and are alternately delimited by teeth 61, i.e. two consecutive teeth 61, 61 delimit a notch 60 and two consecutive notches 60, 60 are separated by a tooth 61. The body 50 is therefore simple to fabricate.

In the embodiment shown the pole wheels each have eight teeth 45 and the body 50 of the stator has 28 teeth, the alternator having seven phases.

Of course, this depends on the application. In one embodiment the number of teeth 61 per phase of the stator is equal to half the number of teeth of each pole wheel of the claw-pole rotor.

Alternatively, the number of teeth per phase of the stator is equal to or twice the number of teeth of a pole wheel.

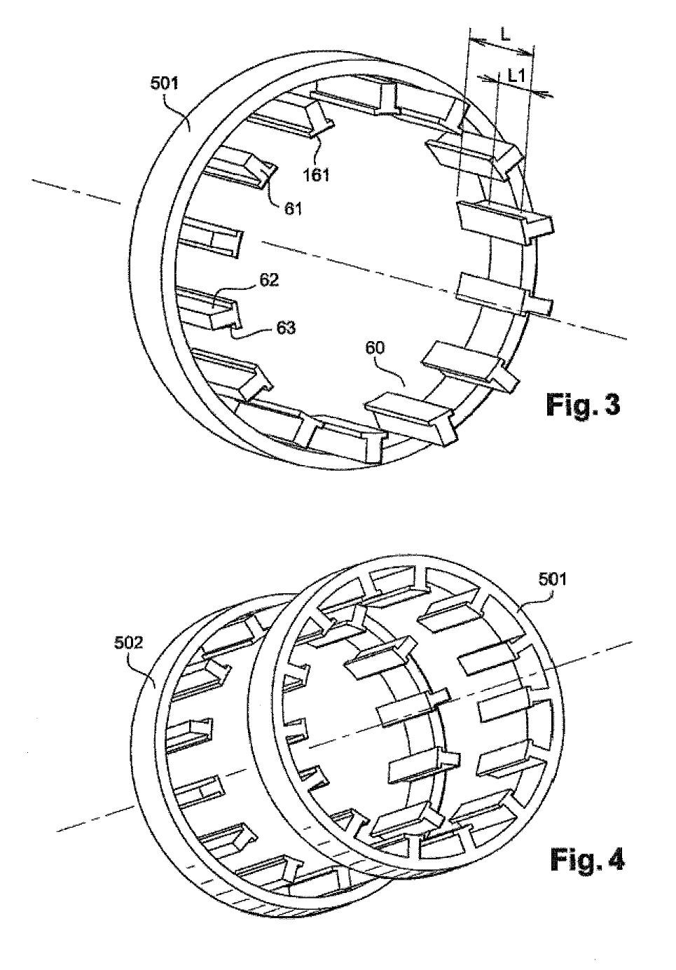

The teeth 61 have parallel edges 63, 62 (FIGS. 3, 5). These teeth are wide, there being a strip of material called the yoke between the bottoms 64 of the notches 60 and the external periphery of the body 50. The parallel edges 63, 62 in FIG. 5 are used to mount preformed coils. Alternatively, direct winding onto the teeth of the stator is possible.

This is precisely what is shown in FIGS. 2 to 4, the teeth 61 including an interior edge 161, called the foot, at the inside periphery of the body 50 of the stator to delimit a semi-closed type notch 60.

To be more precise, the alternator or the alternator-starter motor is of the multiple-phase type and therefore includes coils comprising a number of phases, each phase including at least one winding.

For greater clarity only a portion of the phase winding is represented in FIG. 5.

Each phase winding includes coils 70 produced from wire wound a number of times to form a number of turns 73 (see FIG. 5). These turns 73 have a width 74 and a height 75.

There are seen an input 71 of the winding and an output 72 of the coil 70, this output 72 being connected to another coil 70 so that the coils are connected in clusters.

The wires are of constant section and consist of enamelled copper wire, for example.

Each coil surrounds a single tooth 60. This tooth can be split as represented in dashed line in FIG. 5.

Of course the wires can be of circular, rectangular or flat section.

Accordingly, each phase winding includes coils 70 having turns of constant width. These coils 70 are mounted around the teeth 61 with parallel edges 62, 63.

FIGS. 2 to 5 do not show the notch insulation that can be disposed between the coils and the edges 62, 63 or the bottom 64 of the notch 60 to isolate the coils from the body 50 and prevent damaging their insulation.

Such insulation is described for example in the document FR 2 890 798, which may be referred to.

Of course, in FIG. 5, with open type notches 60, the coils can be mounted around a notch insulator threaded over the tooth concerned and having a lower edge for retaining the coil.

This lower edge replaces the lower edge 161 of the semi-closed type tooth from FIG. 2.

It is therefore important in all cases, given the presence of a large number of teeth 61, to facilitate mounting of the coils 70 on the wound stator 5.

FIG. 2 represents a stator body 50 of the invention comprising two complementary annular parts 501, 502 each having a partial axial length L1, L2. As indicated above, the body 50 includes teeth 61 each of which is intended to carry a coil. Each of the teeth 61 has an axial length L corresponding to the axial length of the body 50. The sum of the two partial axial lengths L1, L2 of the two annular parts 501, 502 of the body 50 is therefore equal to the axial length L of the teeth 61 and the body 50. Thus the coils of the same phase situated on the same part 501, 502 can be wound continuously onto the teeth 61 or easily mounted on the teeth 61 given the room left free by the absence of the other part 502, 501.

FIG. 3 is a diagrammatic perspective view of the part 501 of the body 50 of the stator 5 of the invention. FIG. 3 shows more particularly that the first part 501 of the stator body has a partial length L1 whereas each of the teeth 61 has the total axial length L and the teeth 61 project from the part 501 of the body 50 either in the direction of the axial length of the part 501 or in the same direction. The teeth 61 are in their definitive configuration both with regard to the dimensions of each of the teeth and with regard to the spacing between the teeth.

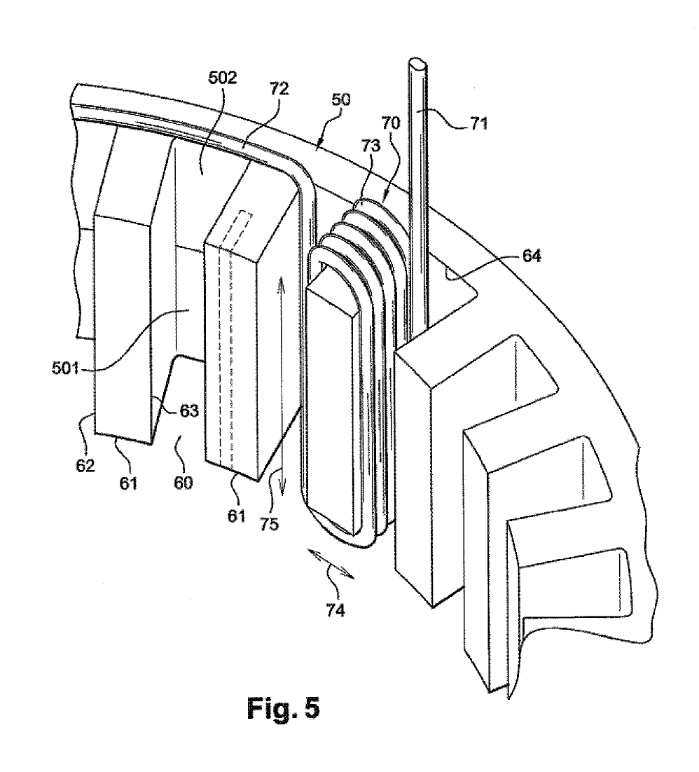

FIG. 4 shows the two parts 501, 502 of the body 50 of the stator 5 axially aligned with each other and angularly offset so that the two parts 501, 502 can be assembled to form the body 50 of the stator 5. The angular disposition of the two parts 501, 502 relative to each other is determined to ensure a homogeneous distribution of the teeth 61 on the assembled body 50.

FIG. 4 shows more particularly that the two parts 501, 502 of the body 50 of the stator 5 of the invention are formed so that, when the two parts are facing each other and axially aligned, the corresponding teeth 61 of each of the two parts respectively extend toward the other part.

Although this is not shown in the drawings, the two parts 501, 502 of the body 50 advantageously include alignment aids, also known as polarisers, that are intended to ensure that the two parts are correctly oriented relative to each other at the time of assembly. These polarisers are formed on the two facing edges of the two parts 501, 502 of the body 50 of the stator 5 and can take the form of axial notches produced in one of the two edges and corresponding tenons on the other edge, for example.

In one embodiment the two parts 501, 502 of the body 50 of the stator 5 are assembled together by screws.

Alternatively, the two parts 501, 502 are welded together at their axial ends in contact with each other.

These parts can be riveted together.

Alternatively, assembly is effected by banding. The rivets, tie-rods, screws are advantageously implanted in the yokes of the parts 501, 502.

In the figures the parts 501, 502 have the same axial length, but their lengths can instead be different.

Of course the stator of the rotary electrical machine can instead be part of a generator of current in the coils of an electromagnetic retarder as described in the document WO 2006/010863, for example.

Generally speaking, this stator can be in contact with a water jacket that surrounds it.

Of course, the length of the teeth can instead be less than the axial length L of the stator body 50. For example, the teeth can project axially from one of the parts to a distance less than the axial length of the other part, so that the bun-shaped assemblies can have different length coil heads.

Thanks to this shorter length of the teeth, the length of the bun-shaped assemblies 51, 52 can be adjusted. One of the bun-shaped assemblies can be of greater axial length than the other bun-shaped assembly.

To be more precise, as described in the document FR 2 785 464, one of the bun-shaped assemblies can instead project further in the axial direction relative to the corresponding axial end face of the body 50 than the other bun-shaped assembly relative to the other axial end face of the body 50 to reduce operating noise caused by movement of air.

This is achieved without having to shift axially the coils of the stator 5, in contrast to the teaching of the document FR 2 785 464.

An offset of 4 to 8 mm can thus be easily obtained, as in the above document, or a smaller offset less than 4 mm. Everything depends on the application.

Alternatively, at least one of the bun-shaped assemblies does not project. That bun-shaped assembly is then covered and protected by the yoke of the body 50.

The stator is then cooled by a water jacket in the manner referred to above, for example as described in the document FR A 2 793 083. Alternatively the fan or each of the fans 9 is an axial-flow fan.

Of course it emerges from the description that the teeth of one of the annular parts of the body of the stator can be a different length to the teeth of the other annular part of the body of the stator.

Of course, the teeth can be attached to each part 501, 502 reduced to a yoke, for example by a dovetail assembly. After mounting the teeth the coils can be wound onto or mounted on the teeth.

1. A stator of a multiple-phase rotary electrical machine, each phase including at least one winding, each winding including coils (70) with a plurality of turns (73), the stator (5) having a body (50) having an axial length (L) and having internally a plurality of notches (60) delimited by teeth (61), each of which teeth (61) is surrounded by a coil (70), wherein the body (50) of the stator (5) comprises two complementary annular parts (501, 502) each annular part having a partial axial length (L1, L2), the teeth (61) of the body (50) being alternately fastened to one of the two annular parts (501, 502) of the body (50) of the stator (5).

2. A stator according to claim 1, wherein the axial lengths (L1, L2) of the two parts (501, 502) of the body (50) of the stator (5) are equal.

3. A stator according to claim 1, wherein the stator (5) is conformed so as to be in thermal contact with a surrounding water jacket.

4. A stator according to claim 1, wherein the teeth (61) of the body (50) of the stator (5) have an axial length equal to that of the body (50) of the stator (5).

5. A stator according to claim 1, wherein the teeth (61) of the body (50) of the stator (5) have an axial length less than that of the body (50) of the stator (5).

6. A stator according to claim 1, wherein the notches (60) have parallel edges (62, 63) and wherein the coils (70) are formed by turns (73) of constant width.

7. A stator according to claim 1, wherein the teeth (61) are enveloped by an electrically-insulative material.

8. A stator according to claim 1, wherein the two annular parts (501, 502) of the body (50) of the stator (5) are assembled by screws or tie-rods.

9. A multiple-phase rotary electrical machine, comprising a stator according to claim 1.

10. A method of producing a stator (5) for a multiple-phase rotary electrical machine wherein each phase includes at least one winding and each winding includes coils (70) with a plurality of turns (73), the stator (5) having a body (50) having an axial length (L) and having internally a plurality of notches (60) delimited by teeth (61), each of which teeth (61) is adapted to be surrounded by a coil (70), the body (50), wherein, starting from a body (50) comprising two complementary annular parts (501, 502) each part having a partial axial length (L1, L2) and being alternately fastened to the teeth (61), said method comprising the following steps:
surrounding with a coil (70) the teeth (61) of the first part (501) of the body (50) of the stator (5) and then the teeth (61) of the second part (502) of the body (50) of the stator (5), and
assembling the two parts (501, 502) of the body (50) of the stator (5).
